(19) United States
(12) Patent Application Publication
(10) Pub. No.: US 2026/0281428 A1
(43) Pub. Date: Sep. 17, 2026

(54) METHODS AND APPARATUS FOR LOCAL AND NON-LOCAL ILLUMINATION COMPENSATION MODEL DERIVATION AND INHERITANCE IN VIDEO CODING

(71) Applicant: MEDIATEK INC., Hsinchu City (TW)

(72) Inventors: Chia-Ming TSAI, Hsinchu City (TW); Cheng-Yen CHUANG, Hsinchu City (TW); Chen-Yen LAI, Hsinchu City (TW); Chih-Hsuan LO, Hsinchu City (TW); Ching-Yeh CHEN, Hsinchu City (TW); Yi-Wen CHEN, San Jose, CA (US); Tzu-Der CHUANG, Hsinchu City (TW); Chih-Wei HSU, Hsinchu City (TW)

(21) Appl. No.: 19/473,076

(22) PCT Filed: Sep. 4, 2024
(86) PCT No.: PCT/CN2024/116710

§ 371 Date: Oct. 6, 2025

Related U.S. Application Data
(60) Provisional application No. 63/591,477, filed on Oct. 19, 2023.
(60) Provisional application No. 63/591,784, filed on Oct. 20, 2023.

(51) Int. Cl. H04N 19/593; H04N 19/105; H04N 19/11; H04N 19/176

(52) U.S. Cl. CPC H04N 19/593; H04N 19/105; H04N 19/11; H04N 19/176

(57) ABSTRACT

A method and apparatus for video coding using Local Illumination Compensation (LIC) are disclosed. According to this method, LIC processing is applied to a reference block of the current block according to one or more LIC models associated with the current block and a reference block for encoding or decoding the current block. A candidate list is generated by inserting one or more LIC candidates associated with said one or more LIC models into the candidate list conditionally depending on one or more conditions, wherein said one or more conditions comprise one or more reference picture indexes, one or more reference picture POC (Picture Order Counts), one or more motion vectors, or a combination thereof. One or more subsequent blocks are processed using information comprising the candidate list.

### CROSS REFERENCE TO RELATED APPLICATIONS

The present invention is a non-Provisional application of and claims priority to U.S. Provisional Patent Application No. 63/591,477, filed on Oct. 19, 2023 and U.S. Provisional Patent Application No. 63/591,784, filed on Oct. 20, 2023. The U.S. Provisional Patent applications are hereby incorporated by reference in their entireties.

### FIELD OF THE INVENTION

The present invention relates to video coding system using Local Illumination Compensation (LIC) for video coding. In particular, the present invention relates to generating a candidate list comprising one or more LIC candidates.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Some new tools relevant to the present invention are reviewed as follows.

### Cross-Component Prediction (CCP) Merge (a.k.a., Non-Local CCP) Mode

For chroma coding, a flag is signalled to indicate whether CCP mode (including the CCLM, CCCM, GLM and their variants) or non-CCP mode (conventional chroma intra prediction mode, fusion of chroma intra prediction mode) is used. If the CCP mode is selected, one more flag is signalled to indicate how to derive the CCP type and parameters, i.e., either from a CCP merge list or signalled/derived on-the-fly. A CCP merge candidate list is constructed from the spatial adjacent, spatial non-adjacent, or history-based candidates. After including these candidates, default models are further included to fill the remaining empty positions in the merge list. In order to remove redundant CCP models in the list, pruning operation is applied. After constructing the list, the CCP models in the list are reordered depending on the SAD costs, which are obtained using the neighbouring template of the current block. More details are described below.

### Spatial Adjacent and Non-Adjacent Candidates

The positions and inclusion order of the spatial adjacent and non-adjacent candidates are the same as those defined in ECM for regular inter merge prediction candidates.

### History-Based Candidates

A history-based table is maintained to include the recently used CCP models, and the table is reset at the beginning of each CTU row. If the current list is not full after including spatial adjacent and non-adjacent candidates, the CCP models in the history-based table are added into the list.

### Default Candidates

CCLM candidates with default scaling parameters are considered, only when the list is not full after including the spatial adjacent, spatial non-adjacent, or history-based candidates. If the current list has no candidates with the single model CCLM mode, the default scaling parameters are {0, ⅛, −⅛, 2/8, − 2/8, ⅜, −⅜, 4/8, − 4/8, ⅝, −⅝, 6/8}. Otherwise, the default scaling parameters are {0, the scaling parameter of the first CCLM candidate+{⅛, −⅛, 2/8, − 2/8, ⅜, −⅜, 4/8, − 4/8, ⅝, −⅝, 6/8}}. The offset parameter is derived according to the default scaling parameter, average neighbouring reconstructed luma sample value, and average neighbouring reconstructed Cb/Cr sample value.

A flag is signalled to indicate whether the CCP merge mode is applied or not. If CCP merge mode is applied, an index is signalled to indicate which candidate model is used by the current block. In addition, CCP merge mode is not allowed for the current chroma coding block when the current CU is coded by Intra Sub-Partitions (ISP) with single tree, or the current chroma coding block size is less than or equal to 16.

### Local Illumination Compensation (LIC)

LIC is an inter prediction technique to model local illumination variation between the current block and its prediction block as a function between a current block template and a reference block template. The parameters of the function can be denoted by a scale α and an offset β, which forms a linear equation, that is, α*p[x]+β to compensate illumination changes, where p[x] is a reference sample pointed to by MV at a location x on reference picture. When wrap around motion compensation is enabled, the MV shall be clipped with wrap around offset taken into consideration. Since α and β can be derived based on current block template and reference block template, no signalling overhead is required for them, except that an LIC flag is signalled for AMVP mode to indicate the use of LIC.

The local illumination compensation proposed in JVET-00066 is used for uni-prediction inter CUs with the following modifications.
Intra neighbour samples can be used in LIC parameter derivation;
LIC is disabled for blocks with less than 32 luma samples;
For both non-subblock and affine modes, LIC parameter derivation is performed based on the template block samples corresponding to the current CU, instead of partial template block samples corresponding to first top-left 16×16 unit;
Samples of the reference block template are generated by using MC with the block MV without rounding it to integer-pel precision.

### Bi-Predictive LIC

In the method, the LIC mode is extended to bi-predictive CUs. Specifically, two different linear models are applied to the two prediction blocks which are then combined to generate the bi-prediction samples of the current CU, i.e.,

$${P}^{′} [ x , y ] = ( 1 - ω ) \cdot {p}_{0}^{′} [ x , y ] + ω \cdot {p}_{1}^{′} [ x , y ]$$

$$and$$

$${p}_{0}^{′} [ x , y ] = {α}_{0} \cdot {P}_{0} [ x , y ] + {β}_{0} ,$$

$${p}_{1}^{′} [ x , y ] = {α}_{1} \cdot {P}_{1} [ x , y ] + {β}_{1} ,$$

where α₀ and β₀, and α₁ and β₁ indicate the scales and the offsets in L0 and L1, respectively; ω indicates the weight (as indicated by the CU-level BCW index) for the weighted combination of L0 and L1 predictions. The same derivation scheme of the LIC mode is reused and applied in one iterative manner to derive the L0 and L1 LIC parameters. Specifically, the method firstly derives the L0 parameters by minimizing difference between L0 template prediction T₀ and the template T and the samples in T are updated by subtracting the corresponding samples in T₀. Then, the L1 parameters are calculated that minimizes the difference between L1 template prediction T₁ and the updated template. Finally, the L0 parameter is refined again in the same way.

Following the current LIC design, one flag is signalled for AMVP bi-predicted CUs for the indication of the LIC mode while the flag is inherited for merge related inter CUs. Additionally, the LIC is disabled when decoder-side motion vector refinement (DMVR) (including multi-pass DMVR, adaptive DMVR and affine DMVR) and bi-directional optical flow (BDOF) is applied.

OBMC with LIC

In the method, the OBMC is enabled for the inter blocks that are coded with the LIC mode. In order to reduce the complexity, the OBMC is only applied to the top and left CU boundaries while being always disabled for the boundaries of the internal sub-blocks of one LIC CU. Additionally, when one neighbouring block is coded with the LIC, its LIC parameters are applied to generate the corresponding prediction samples for the OBMC of one current block.

LIC Flag Derivation for Merge Candidates with Template Costs

In JVET-AF0128 (EE2-3.2), it is proposed to derive the LIC flag of a merge candidate based on template costs.

The LIC flag of a merge candidate is derived by comparing two template costs: a SAD-based template cost, denoted as C0, and a Mean Removal SAD (MRSAD)-based template cost, denoted as C1. The LIC flag is set to be false, if C0<=C1 and is set to be true, if C0>C1.

To favor the inherited LIC flag, C0 is multiplied by α if the inherited LIC flag is false while C1 is multiplied by a if the inherited LIC flag is true, where α<1.

In the present invention, methods and apparatus to improve the coding performance of LIC process, some conditions for allowing an LIC candidate to be inserted into the candidate list are disclosed.

### BRIEF SUMMARY OF THE INVENTION

A method and apparatus for video coding using Local Illumination Compensation (LIC) are disclosed. According to this method, input data associated with a current block is received, wherein the input data comprise pixel data to be encoded at an encoder side or data associated with the current block to be decoded at a decoder side. Local Illumination Compensation (LIC) processing is applied to a reference block of the current block according to one or more LIC models associated with the current block and the reference block for encoding or decoding the current block. A candidate list is generated by inserting one or more LIC candidates associated with said one or more LIC models into the candidate list conditionally depending on one or more conditions, wherein said one or more conditions comprise one or more reference picture indexes, one or more reference picture POC (Picture Order Counts), one or more motion vectors, or a combination thereof. One or more subsequent blocks are processed using information comprising the candidate list.

In one embodiment, said one or more LIC candidates associated with the reference block are inserted into the candidate list only when said one or more conditions are satisfied.

In one embodiment, only when said one or more reference picture indexes of the current block and the reference block are the same, said one or more LIC candidates are inserted into the candidate list. For example, if the current block is bi-prediction coded, only when reference picture index of reference picture list L0 and reference picture index of reference picture list L1 of the current block and the reference block are the same, said one or more LIC candidates are inserted into the candidate list. In another example, if the current block is uni-prediction coded with reference picture list L0 or L1, only when reference picture index of the reference picture list L0 or reference picture index of the reference picture list L1 for both the current block and the reference block is the same respectively, said one or more LIC candidates are inserted into the candidate list.

In one embodiment, only when said one or more reference picture POC of the current block and the reference block are the same, said one or more LIC candidates are inserted into the candidate list. For example, if the current block is bi-prediction coded, only when reference picture POC of reference picture list L0 and reference picture POC of reference picture list L1 of the current block and the reference block are the same, said one or more LIC candidates are inserted into the candidate list. In another example, if the current block is uni-prediction coded with associated reference picture list L0, only when reference picture POC of the reference picture list L0 for the reference block is the same as the reference picture POC of the reference picture list L0 or reference picture POC of reference picture list L1 of the current block, the LIC candidate associated with the reference picture list L0 of the reference block is inserted into the candidate list. Otherwise, if the reference picture POC of the reference picture list L1 for the reference block is the same as the reference picture POC of the reference picture list L0 of the current block, the LIC candidate associated with the reference picture list L1 of the reference block is inserted into the candidate list. In one embodiment, the LIC candidate associated with the reference picture list L1 of the reference block is further used to refine the reference picture list L0 predictor of the current block.

In one embodiment, only when said one or more motion vectors of the current block and the reference block are similar, said one or more LIC candidates are inserted into the candidate list. For example, if said one or more motion vectors of the current block are positive for both x-axis and y-axis, and said one or more motion vectors of the reference block are also positive for both the x-axis and the y-axis, said one or more LIC candidates are inserted into the candidate list. In another example, if said one or more motion vectors of the current block are negative for both x-axis and y-axis, and said one or more motion vectors of the reference block are also negative for both the x-axis and the y-axis, said one or more LIC candidates are inserted into the candidate list. In yet another example, if one or more first reference blocks pointed by said one or more motion vectors of the current block, and one or more second reference blocks pointed by said one or more motion vectors of the reference block are close, said one or more LIC candidates are inserted into the candidate list. In another embodiment, if said one or more first reference blocks and said one or more second reference blocks are in a same reference picture, a same CTU or a same CTU row, said one or more LIC candidates are inserted into the candidate list. In another example, if a position of said one or more first reference blocks and a corresponding position of said one or more second reference blocks are within N pels in both x-axis and y-axis, said one or more LIC candidates are inserted into the candidate list, and wherein N is a positive integer.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of storing the inter coding or LIC model in CTU-level buffer to picture-level buffer, where the left-above position marked in slash of each 2×2 grids is saved to the picture-level buffer.

FIG. 3 illustrates a flowchart of an exemplary video coding system that an LIC (Local Illumination Compensation) candidate is conditionally inserted into a candidate list according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In order to improve the coding performance of video system incorporating LIC (Local Illumination Compensation), methods and apparatus of conditionally inserting an LIC candidate into the candidate list are disclosed.

### I. LIC Merge Mode

In one embodiment, an LIC merge list is generated, where the LIC merge list consists of spatial neighbouring block's LIC parameters, non-adjacent neighbouring block's LIC parameters, temporal neighbouring block's LIC parameters, and history-based block's LIC parameters as mentioned in the previous section. In addition, default LIC parameters can also be included in the LIC merge list.

For example, the default LIC parameters are generated by some pre-defined alpha values. After that, the reference templates of the reference block and the current templates of the current block are used to derive the corresponding beta values.

For example, the pre-defined alpha values are closed to 1. For another example, the pre-defined alpha values can be negative or positive.

In one embodiment, if the reference block is coded by multi-model LIC, more than one LIC models will be inserted into LIC merge list.

In one embodiment, if the reference block is coded with slope-adjustment LIC, the adjusted parameters will be inserted into LIC merge list.

In one embodiment, in inter AMVP mode, a CU-level flag is signalled to indicate whether LIC merge mode is used or not. If it is true, an index will be further signalled to indicate which LIC model in LIC merge list is used.

In one embodiment, in inter merge mode, a CU-level flag is signalled to indicate whether LIC merge mode is used or not. If it is true, an index will be further signalled to indicate which LIC model in LIC merge list is used.

In one embodiment, when performing MVP list derivation, LIC is disabled.

In one embodiment, when performing block level reference picture list reordering, LIC is disabled.

In one embodiment, when performing BVD prediction, LIC is disabled.

In another embodiment, after decoding a block, one or more LIC models of the current block are derived and stored for later reconstruction process of to-be-coded blocks using inherited neighbours model parameter. For example, if the current block is coded by LIC prediction, the first LIC model used for the current block is stored, and after the reconstruction of the current block, the second LIC model of the current block is derived by using the reconstruction samples from the current block and reference region (e.g., identified by the current block size and motion vector). Later, if another block is predicted by using inheriting neighbours LIC model parameters, the LIC model of another block can be inherited from the stored first and second LIC models of the current block. In other words, the stored first and second LIC models of the current block can be the candidates in the LIC merge list of another block.

I.1 Inheriting from Shared LIC Models

Current picture or slice is segmented into multiple non-overlapped regions, and each region size is M×N. A shared LIC model is derived for each region, respectively. In one embodiment, the neighbouring available reconstruction samples of the current region and the corresponding reference region (e.g., region derived according to the motion information of blocks inside the current region) are used to derive the shared LIC model of the current region. Then, for a block inside the current region, it can determine whether to inherit the shared LIC model or derive LIC model by the neighbouring samples of the block and the reference block. In one embodiment, the M×N can be a predefined value (e.g. 128×128, 64×64, 32×32), a signalled value (e.g. signalled in sequence/picture/slice/tile-level), a derived value (e.g. depending on the CTU size), or the maximum allowed transform block size.

In another embodiment, each region can have more than one shared LIC model. For example, it can use various neighbouring template (e.g., top and left neighbouring samples, top-only neighbouring samples, left-only neighbouring samples) to derive more than one shared LIC model. Besides, the shared LIC models of the current region can be inherited from previously used LIC models. For example, the shared model can be inherited from the models of adjacent spatial neighbours, non-adjacent spatial neighbours, temporal neighbours, or from a historical list.

In another embodiment, after the reconstruction of a region, the reconstruction samples inside the current region and the corresponding reference region are used to derive the shared LIC model of the current region. The later to-be-coded blocks can determine whether to inherit the shared LIC model from the current region or not. Besides, each region can have more than one shared LIC model. For example, various portion of the reconstruction samples inside the current region and the corresponding reference region can be chosen to derive more than one shared LIC models.

When doing signalling, a first flag can be used to determine if the current LIC model is inherited from the shared LIC models or not. If the current LIC model is inherited from the shared LIC models, the second syntax indicate the inherited index of the shared LIC models (e.g., signalled using truncate unary code, Exp-Golomb code, or fix length code).

### I.2 Storing LIC Information in CTU-Level and Picture-Level Buffers

To store the LIC model (e.g., prediction mode, related sub-mode flags, prediction pattern, or model parameters) for further model inheritance, the buffer for storing inter coding information (e.g., motion vector buffer) is shared with CC merge mode for storing LIC model. Suppose the minimal allowed block size is m×n the current CTU size is p×q, and the current picture size is r×s.

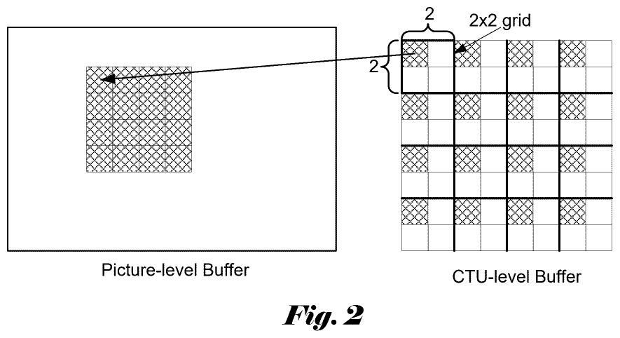

A CTU-level buffer and picture-level buffers are used for storing the LIC models of the current CTU and each picture, respectively. A CTU-level buffer is created for storing the LIC models, and this CTU-level buffer size is ┌p/m┐×┌q/n┐. A picture-level buffer is created for storing the final LIC models of the current picture, and this picture-level buffer size is ┌r/i┐×┌s/j┐, where i≥m and j≥n. After encoding or decoding the current block, the LIC model of the current block is firstly saved to the corresponding positions of CTU-level buffer in unit of m×n, where the corresponding positions are the positions covered by the current block in unit of m×n. Later, after encoding or decoding the current CTU, the LIC model in the current CTU-level buffer are saved to the corresponding positions of the picture-level buffer in unit of i×j. However, if the unit of CTU-level buffer and picture-level buffer are not the same (e.g., i>m or j>n), the LIC model in CTU-level buffer can be subsampled for saving into the picture-level buffer. Suppose i/m=g and j/n=h, one of each g×h grids of CTU-level buffer is selected to save the LIC model to the corresponding position of the picture-level buffer. For example, as shown in FIG. 2, if g=2 and h=2, one selected position of each 2×2 grid is selected to save the LIC model to the corresponding position of the picture-level buffer. In one embodiment, the selected position can be the left-above, left-bottom, right-above, or right-bottom of each 2×2 grid. As shown in FIG. 2, the LIC model at first grid of each 2×2 grid (e.g., the left-above position marked in slash) is saved to the picture-level buffer. When selecting the candidate for saving to picture-level buffer, it can follow a predefined scanning order to select the first allowed candidate. For example, if the selected and saved data is LIC model, it can select the first grid inside the g×h grids has LIC model by a predefined scanning order.

### I.3 Region-Wise LIC Merge Method

The current block is partitioned into two or more prediction regions/sub-blocks, each region can be predicted by an inter or intra coding tool, and at least one of prediction regions is coded by LIC merge mode where the LIC model of the at least one region is inherited from a spatial, historical, or temporal neighbouring block/position. In one embodiment, the current block is partitioned by quad-tree, binary-tree, or ternary-tree split. The split can be symmetric or asymmetric split.

In another embodiment, the current block is partition into two regions, one of two regions is predicted by inter or intra coding tool, and another one is predicted by LIC merge mode. The inherit candidate index of the region predicted by LIC merge mode can be explicitly or implicitly indicated. For example, it can explicitly signal the candidate index by truncate unary code, Exp-Golomb code, or fixed-length code. For another example, it can implicitly select the first candidate in the list as the candidate index. The candidates in the list can be reordered according to the template cost.

In still another embodiment, the current block is partition into two regions, two regions are both predicted by LIC merge mode, and the first two candidates in the list are the candidate index of the two regions. It can implicitly set the candidate index of the first region (e.g., the region having the top-left sample of the current block) to the first candidate and set the candidate index of the second region to the second candidate. Besides, the list can be reordered according to the template cost. For another example, if two regions are both predicted by LIC merge mode, an index is explicitly signalled to indicate the candidate index of the first region, and the candidate index of the second region is the signalled index+k or the signalled index−k, where k can be 1, 2, 3, 4, or 5. For still the same example, the candidate index of the first region is implicitly derived from the stored LIC model at the top-left position of the current block relative to the top-left position in the previous coded slices/pictures. In another embodiment, if two regions are both predicted by LIC merge mode, the first candidate in the list is the candidate index of the two regions.

### II. LIC for Merge Mode

In one embodiment, the second flag can be signalled to indicate whether the first derived LIC flag of a merge candidate is correct or not. In this case, the first derived LIC flag is derived based on template costs. If SAD-based template cost<=a Mean Removal SAD (MRSAD)-based template cost, set the first derived LIC to false. If SAD-based template cost>a Mean Removal SAD (MRSAD)-based template cost, set the first derived LIC to true.

For example, if SAD-based template cost<=a Mean Removal SAD (MRSAD)-based template cost, the first derived LIC will be false, and the second signalled flag is true. In this case, LIC will not be used for the current CU.

For another example, if SAD-based template cost<=a Mean Removal SAD (MRSAD)-based template cost, the first derived LIC will be false, and the second signalled flag is false. In this case, LIC will be used for the current CU.

For another example, if SAD-based template cost>a Mean Removal SAD (MRSAD)-based template cost, the first derived LIC will be true, and the second signalled flag is true. In this, LIC will be used for the current CU.

For another example, if SAD-based template cost>a Mean Removal SAD (MRSAD)-based template cost, the first derived LIC will be true, and the second signalled flag is false. In this case, LIC will not be used for the current CU.

In one embodiment, the second flag is coded by context coded bin.

In one embodiment, the second flag is coded by more than one context variables. The selection of the context variable is depended on the on-off of LIC of neighbouring blocks. For example, the top CU and the left CU are referenced.

In one embodiment, the second flag is coded by more than one context variables. The selection of the context variable is dependent on the current CU coding mode. For example, the context variables for affine mode coded CU and non-affine mode coded CU are different. For another example, the context variables for IBC coded CU and non-IBC coded CU are different.

In one embodiment, the second flag is only signalled for some specific merge modes. For other merge modes, the second flags don't need to be signalled. They will always be set to true. For example, regular merge mode and MMVD merge mode need to signal the second flag. For another example, only non-skip merge mode needs to signal the second flag.

In one embodiment, the second flag is only signalled for some specific merge modes. For some merge modes, the second flags don't need to be signalled. They will always be set to true. For other merge modes (e. g. TM merge mode), implicit methods are used to indicate the on-off of the second flags. For example, TM cost is used to indicate the on-off of the second flag. For another example, second on-off flag of neighbouring blocks can be referenced to determine the second on-off flag of the current block.

### III. LIC for AMVP-Merge

In one embodiment, an LIC flag is signalled when AMVP-Merge mode is applied.

In one embodiment, a second LIC flag is signalled when AMVP-Merge mode is applied. In this case, the second LIC flag is used to indicate whether LIC is applied or not. In this case, if LIC is applied, and the LIC flag from the corresponding merge candidate is true, the second LIC flag will be set to true. Otherwise, if LIC is applied, and the LIC flag from the corresponding merge candidate is false, the second LIC flag will be set to false.

In one embodiment, the second LIC flag is coded by context coded bin.

In one embodiment, the second LIC flag is coded by more than one context variables. The selection of the context variable is depended on the on-off of LIC of neighbouring blocks. For example, the top CU and the left CU are referenced.

In one embodiment, in AMVP-Merge mode, no LIC flag needs to be signalled. LIC will be always disabled.

In one embodiment, in AMVP-Merge mode, during reordering of merge candidates list, candidates' BM costs will be calculated and compared. All merge candidates in merge candidate list will be treated as LIC-off candidates during reordering.

In one embodiment, in AMVP-Merge mode, the LIC parameters of the corresponding merge candidates can be used to guide the LIC parameters derivation of the current CU. The LIC parameters of the current CU are derived based on templates of the current block and templates of the reference block. For example, a regularization term can be added during the derivation of LIC parameters of current CU. The regularization term is designed based on the corresponding merge candidate' LIC parameters and a lambda value. The lambda value is used to control the strength of the guidance.

In one embodiment, in AMVP-Merge mode, the LIC parameters of the corresponding merge candidates can be used for current CU. In this case, LIC parameters of the current CU don't need to be derived again.

### II.4 LIC for Improved Merge Mode

In one embodiment, an LIC merge list is generated including more than one referenced block LIC parameter. In this case, the referenced blocks can be spatial candidates, non-adjacent candidates, history-based candidates, and pre-defined default candidates.

In one embodiment, the reference picture index is checked when inserting an LIC merge candidate into LIC merge list. Only when an LIC merge candidate comes from a reference block with the same reference picture index as the current block or the same subset of reference picture indexes as the current block, it can be inserted into LIC merge candidate list.

For example, if the current block is bi-prediction, reference picture index L0 (refIdxL0) and reference picture index L1 (refIdxL1) will be checked. Only when both refIdxL0 and refIdxL1 of the referenced block are the same as refIdxL0 and refIdxL1 of the current block, the LIC merge candidate of the referenced block can be inserted into LIC merge candidate list. In this case, the reference block can be a bi-prediction block only.

For another example, if the current block is an L0 uni-prediction block, only when refIdxL0 of the referenced block are the same as refIdxL0 of current block, the LIC merge candidate of the referenced block can be inserted into LIC merge candidate list. In this case, the reference block can be a uni-prediction block or a bi-prediction block.

For another example, if the current block is an L1 uni-prediction block. Only when refIdxL1 of the referenced block is the same as refIdxL1 of the current block, the LIC merge candidate of the referenced block can be inserted into LIC merge candidate list. In this case, the reference block can be a uni-prediction block or a bi-prediction block.

In one embodiment, the referenced picture POC of reference block is checked when inserting an LIC merge candidate into LIC merge candidate list. Only when an LIC merge candidate comes from a reference block with the same reference picture as the current block, it can be inserted into LIC merge candidate list.

For example, if current block is a bi-prediction block, refPicPocL0 and refPicPocL1 will be checked. Only when refPicPocL0 of the reference block is the same as refPicPocL0 or refPicPocL1 of the current block, and refPicPocL1 of the reference block is the same as refPicPocL0 or refPicPocL1 of the current block, it can be inserted into LIC merge candidate list.

For another example, if the current block is an L0 uni-prediction block, only if refPicPocL0 of the reference block is the same as refPicPocL0 or refPicPocL1 of the current block, it can be inserted into LIC merge candidate list. In this, if refPicPocL0 of reference block is the same as refPicPocL0 of the current block, the LIC parameters for L0 of the reference block will be inserted into LIC merge list. Otherwise, if refPicPocL1 of the reference block is the same as refPicPocL0 of the current block, the LIC parameters for L1 of the reference block will be inserted into LIC merge list and it will be performed to refine L0 predictor of the current block.

In one embodiment, the reference block's MV is checked when inserting an LIC merge candidate into LIC merge candidate list. Only when an LIC merge candidate comes from a reference block with an MV similar to the MV of the current block, it can be inserted into LIC merge candidate list.

For example, the MV signs of both-axis and y-axis components of the current block are positive, the MV signs of the x-axis and y-axis components of the inserted reference block shall also be both positive.

For another example, the MV signs of both-axis and y-axis components of the current block are negative, the MV signs of the x-axis and y-axis components of the inserted reference block shall also be both negative.

For another example, the pointed reference block of the current block and the pointed reference block of the reference block of LIC parameters shall be closed. For example, they shall be in the same reference picture. For another example, the top-left position of the pointed reference block of the current block and the pointed reference block of the reference block of LIC parameters shall be within N integer-pel in both x-axis and y-axis. N can be any integer value larger than 0. For another example, they shall be in the same CTU. For another example, they shall be in the same CTU row.

In one embodiment, two LIC merge lists will be generated. The first LIC merge list is used to store referenced LIC parameters of L0. The second LIC merge list is used to store referenced LIC parameters of L1. For a bi-prediction reference block, the LIC parameters of L0 is stored in the first LIC merge list and LIC parameters of L1 is stored in the second LIC merge list.

In that, if the current block is a bi-prediction block, a candidate in the first LIC merge list will be used to refine L0 predictor of the current block, and a candidate in the second LIC merge list will be used to refine L1 predictor of the current block.

If the current block is a uni-prediction block from L0, a candidate in the first LIC merge list will be used to refine L0 predictor of the current block.

If the current block is a uni-prediction block from L1, a candidate in the second LIC merge list will be used to refine L1 predictor of the current block.

In one embodiment, two indices are signalled in the bitstream to indicate the first candidate used to refine L0 predictor of the current block from the first LIC merge list and the second candidate used to refine L1 predictor of current block from the second LIC merge list.

In one embodiment, one index is signalled in the bitstream to indicate the pair of first candidate used to refine L0 predictor of the current block, and the second candidate used to refine L1 predictor of the current block. A pre-defined list including M combination pair of candidates from two lists is designed. The signalled index is used to indicate one pair from the pre-defined list.

In one embodiment, no additional syntax is signalled in the bitstream to indicate the first and second candidate pair used to refine L0 predictor and L1 predictor. Instead, TM reordering is performed at both the encoder and decoder to check all combinations and reorder the list. After that, the best combination can be derived. The best combination will be used to indicate the first candidate used to refine L0 predictor of the current block from the first LIC merge list and the second candidate used to refine L1 predictor of the current block from the second LIC merge list.

In one embodiment, if the current block is a bi-prediction block, L0 predictor is predicted from refPicL0, and L1 predictor is predicted from refPicL1, two LIC merge lists will be generated. The first LIC merge list is used to store referenced LIC parameters from the reference block predicted based on refPicL0. The second LIC merge list is used to store referenced LIC parameters from reference block predicted based on refPicL1. In this case, a candidate in the first LIC merge list will be used to refine L0 predictor of the current block, and a candidate in the second LIC merge list will be used to refine L1 predictor of the current block. The reference block that LIC parameters are referenced from can be a uni-prediction block, or a bi-prediction block.

In one embodiment, if the current block is an L0 uni-prediction block, L0 predictor is predicted from refPicL0. A nLIC merge list is used to store referenced LIC parameters from reference block predicted based on refPicL0. In this case, a candidate in the LIC merge list will be used to refine L0 predictor of the current block. In this case, the reference block that LIC parameters are referenced from can be a uni-prediction block, or a bi-prediction block.

In one embodiment, if the current block is an L1 uni-prediction block, L1 predictor is predicted from refPicL1. An LIC merge list is used to store referenced LIC parameters from the reference block predicted from refPicL1. In this case, a candidate in the LIC merge list will be used to refine L1 predictor of the current block. In this case, the reference block that LIC parameters are referenced from can be a uni-prediction block, or a bi-prediction block.

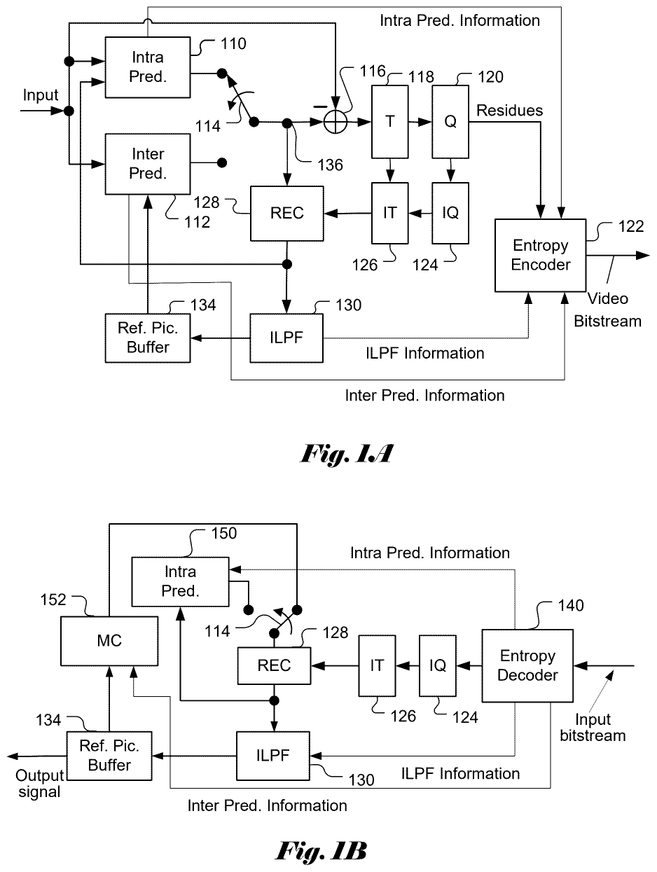

Any of the foregoing proposed LIC process methods can be applied independently or jointly. Moreover, any of the foregoing proposed LIC process methods can be implemented in encoders and/or decoders. For example, any of the proposed methods can be implemented in inter prediction module of an encoder and/or a decoder. Alternatively, any of the proposed methods can be implemented as a circuit coupled to inter prediction module of the encoder and/or the decoder. With reference to the reference encoder and decoder of FIG. 1A and FIG. 1B, any of the proposed LIC process can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed LIC process can also be implemented as a circuit coupled to the intra/inter coding module at the decoder or the encoder. However, the decoder or encoder may also use additional processing unit to implement the required LIC processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

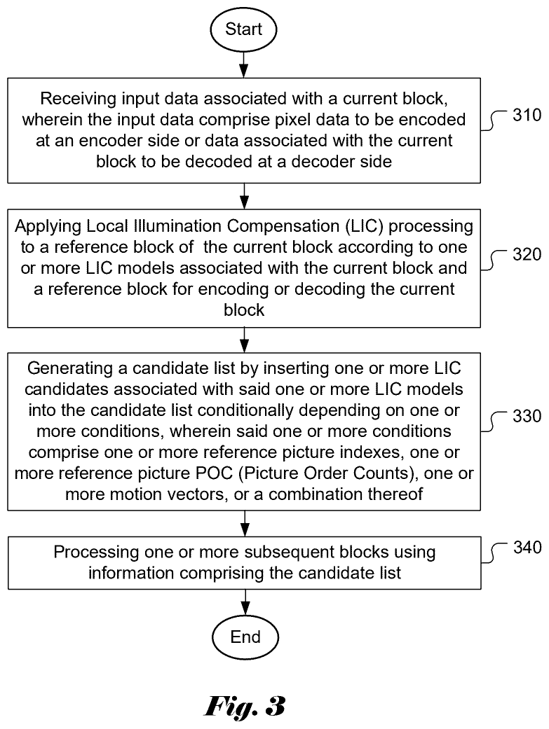

FIG. 3 illustrates a flowchart of an exemplary video coding system that an LIC (Local Illumination Compensation) candidate is conditionally inserted into a candidate list according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block is received in step 310, wherein the input data comprise pixel data to be encoded at an encoder side or data associated with the current block to be decoded at a decoder side. Local Illumination Compensation (LIC) processing is applied to a reference block of the current block according to one or more LIC models associated with the current block and a reference block for encoding or decoding the current block in step 320. A candidate list is generated by inserting one or more LIC candidates associated with said one or more LIC models into the candidate list conditionally depending on one or more conditions in step 330, wherein said one or more conditions comprise one or more reference picture indexes, one or more reference picture POC (Picture Order Counts), one or more motion vectors, or a combination thereof. One or more subsequent blocks are processed using information comprising the candidate list in step 340.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data to be encoded at an encoder side or data associated with the current block to be decoded at a decoder side;
applying Local Illumination Compensation (LIC) processing to a reference block of the current block according to one or more LIC models associated with the current block and the reference block for encoding or decoding the current block;
generating a candidate list by inserting one or more LIC candidates associated with said one or more LIC models into the candidate list conditionally depending on one or more conditions, wherein said one or more conditions comprise one or more reference picture indexes, one or more reference picture POC (Picture Order Counts), one or more motion vectors, or a combination thereof; and
processing one or more subsequent blocks using information comprising the candidate list.

2. The method of claim 1, wherein said one or more LIC candidates associated with the reference block are inserted into the candidate list only when said one or more conditions are satisfied.

3. The method of claim 2, wherein only when said one or more reference picture indexes of the current block and the reference block are the same, said one or more LIC candidates are inserted into the candidate list.

4. The method of claim 3, wherein if the current block is bi-prediction coded, only when reference picture index of reference picture list L0 and reference picture index of reference picture list L1 of the current block and the reference block are the same, said one or more LIC candidates are inserted into the candidate list.

5. The method of claim 3, wherein if the current block is uni-prediction coded with reference picture list L0 or L1, only when reference picture index of the reference picture list L0 or reference picture index of the reference picture list L1 for both the current block and the reference block is the same respectively, said one or more LIC candidates are inserted into the candidate list.

6. The method of claim 2, wherein only when said one or more reference picture POC of the current block and the reference block are the same, said one or more LIC candidates are inserted into the candidate list.

7. The method of claim 6, wherein if the current block is bi-prediction coded, only when reference picture POC of reference picture list L0 and reference picture POC of reference picture list L1 of the current block and the reference block are the same, said one or more LIC candidates are inserted into the candidate list.

8. The method of claim 6, wherein if the current block is uni-prediction coded with reference picture list L0, only when reference picture POC of the reference picture list L0 for the reference block is the same as the reference picture POC of the reference picture list L0 or reference picture POC of reference picture list L1 of the current block, the LIC candidate associated with the reference picture list L0 of the reference block is inserted into the candidate list.

9. The method of claim 8, wherein otherwise, if the reference picture POC of the reference picture list L1 for the reference block is the same as the reference picture POC of the reference picture list L0 of the current block, the LIC candidate associated with the reference picture list L1 of the reference block is inserted into the candidate list.

10. The method of claim 9, wherein the LIC candidate associated with the reference picture list L1 of the reference block is further used to refine reference list L0 predictor of the current block.

11. The method of claim 2, wherein only when said one or more motion vectors of the current block and the reference block are similar, said one or more LIC candidates are inserted into the candidate list.

12. The method of claim 11, wherein if said one or more motion vectors of the current block are positive for both x-axis and y-axis, and said one or more motion vectors of the reference block are also positive for both the x-axis and the y-axis, said one or more LIC candidates are inserted into the candidate list.

13. The method of claim 11, wherein if said one or more motion vectors of the current block are negative for both x-axis and y-axis, and said one or more motion vectors of the reference block are also negative for both the x-axis and the y-axis, said one or more LIC candidates are inserted into the candidate list.

14. The method of claim 11, wherein if one or more first reference blocks pointed by said one or more motion vectors of the current block, and one or more second reference blocks pointed by said one or more motion vectors of the reference block are close, said one or more LIC candidates are inserted into the candidate list.

15. The method of claim 14, wherein if said one or more first reference blocks and said one or more second reference blocks are in a same reference picture, a same CTU or a same CTU row, said one or more LIC candidates are inserted into the candidate list.

16. The method of claim 14, wherein if a position of said one or more first reference blocks and a corresponding position of said one or more second reference blocks are within N pels in both x-axis and y-axis, said one or more LIC candidates are inserted into the candidate list, and wherein N is a positive integer.

17. An apparatus for video coding, the apparatus comprising one or more electronics or processors arranged to:
receive input data associated with a current block, wherein the input data comprise pixel data to be encoded at an encoder side or data associated with the current block to be decoded at a decoder side;
apply Local Illumination Compensation (LIC) processing to a reference block of the current block according to one or more LIC models associated with the current block and the reference block for encoding or decoding the current block;
generate a candidate list by inserting one or more LIC candidates associated with said one or more LIC models into the candidate list conditionally depending on one or more conditions, wherein said one or more conditions comprise one or more reference picture indexes, one or more reference picture POC (Picture Order Counts), one or more motion vectors, or a combination thereof; and
process one or more subsequent blocks using information comprising the candidate list.
